(19) United States
(12) Patent Application Publication
(10) Pub. No.: US 2010/0115392 A1
(43) Pub. Date: May 6, 2010

(54) Method and System for Building Data Objects for Online Display Advertising

(76) Inventors: Chris Jaffe, Burlingame, CA (US); Lin Su, Los Angeles, CA (US); Nina Shih, Bellevue, WA (US)

Correspondence Address: Stattler-Suh PC, 60 SOUTH MARKET, SUITE 480, SAN JOSE, CA, 95113, US

(21) Appl. No.: 12/263,220

(22) Filed: Oct. 31, 2008

(51) Int. Cl. G06F 17/00

(52) U.S. Cl. 715/224

(57) ABSTRACT

A method and system are provided for building data objects for online display advertising. In one example, the method includes providing two or more forms configured for receiving data objects for an ad campaign, wherein the two or more forms sufficiently compartmentalize the ad campaign in order to facilitate entry of the data objects, providing a navigation interface configured for facilitating navigation among the two or more forms, receiving the data objects into the two or more forms, and receiving at least one request into the navigation interface.

### FIELD OF THE INVENTION

The present invention relates to online display advertising. More particularly, the present invention relates to building data objects for online display advertising.

### BACKGROUND OF THE INVENTION

Electronic ad exchanges, including online auctions and guaranteed deliveries, have proliferated along with the Internet. These electronic exchanges aim to provide a high degree of trading efficiency by bringing together a large number of buyers and sellers. Such exchanges are focused on directly matching the bids and offers of buyers and sellers. Conventional transactions on the exchange are between (i) buyers and sellers, (ii) intermediaries (e.g., brokers, which may be a buyer or seller), or (iii) buyers or sellers and intermediaries.

The proliferation of Internet activity has also generated tremendous growth for advertising on the Internet. Typically, advertisers (i.e., buyers of ad space) and online publishers (sellers of ad space) have agreements with one or more advertising networks (ad networks), which provide for serving an advertiser's banner or ad across multiple publishers, and concomitantly provide for each publisher having access to a large number of advertisers. Ad networks (which may also manage payment and reporting) may also attempt to target certain Internet consumers (i.e., users) with particular advertisements to increase the likelihood that the consumer will take an action with respect to the ad. From an advertiser's perspective, effective targeting is important for achieving a high return on investment (ROI).

Online advertising markets exhibit undesirable inefficiencies when buyers and sellers are unable to transact. For instance, although a publisher may be subscribed to many ad networks, and one or more of those ad networks may transact inventory with other ad networks, only one of the ad networks to which the publisher is subscribed will be involved in selling (e.g., auctioning or guaranteeing delivery) a given ad space for the publisher. The publisher, or a gatekeeper used by the publisher, selects or prioritizes which ad network (or advertiser having a direct agreement with the publisher) will serve the impression for a given ad request.

Further, in online display advertising, advertisers may wish to target broad consumer segments (e.g., California consumers) or specific consumer segments (e.g., males of ages 20-34 in California browsing finance pages). Advertisers need the ability to specify succinctly their values for and exposure (i.e., number of ad views) to various consumer segments, from broad to narrow.

Advertisers spend long hours specifying an ad campaign which, most of the time, ends up not being portable. Once an ad campaign is written down into a contract, a company such as Yahoo!® invests long hours translating the ad campaign into scripts which are used to access the inventory and allocate ads.

Driven by the shift from broadcast to interactive media, almost every aspect of advertising is being automated, including its sale, delivery, and measurement. Moving away from the real estate metaphor of buying space, advertisers may now buy very specific contextual events like “male user visits sports page on the weekend”, or more generally bundles of contextual events. As a result, advertisers need more flexible and expressive ways to describe their ad campaign goals.

Advertisers typically use forms to define their ad campaigns. The successful and accurate creation of data objects in application systems, such as an ad exchange system, is critical to driving profitability and efficiency. The traditional approach is to use conventional forms. Unfortunately, conventional forms are tedious because the forms are typically unduly long. Advertisers oftentimes fail to complete the forms. A partially complete form results in fewer objects being created. Having fewer objects is problematic because a comprehensive expression of an ad campaign is necessary for an ad server to deliver efficiently the appropriate ads.

Within this document, one of ordinary skill recognizes certain abbreviations such as, for example, CPI (cost per impression), CPM (cost per 1000 impressions), CPC (cost per click), CPA (cost per acquisition), eCPM (effective CPM).

### SUMMARY OF THE INVENTION

What is needed is an improved method having features for addressing the problems mentioned above and new features not yet discussed. Broadly speaking, the present invention fills these needs by providing a method and system for building data objects for online display advertising is disclosed. It should be appreciated that the present invention can be implemented in numerous ways, including as a method, a process, an apparatus, a system or a device. Inventive embodiments of the present invention are summarized below.

In one embodiment, a method is provided for building data objects for online display advertising. The method comprises providing two or more forms configured for receiving data objects for an ad campaign, wherein the two or more forms sufficiently compartmentalize the ad campaign in order to facilitate entry of the data objects, providing a navigation interface configured for facilitating navigation among the two or more forms, receiving the data objects into the two or more forms, and receiving at least one request into the navigation interface.

In another embodiment, a system is provided for building data objects for online display advertising. The system is configured for providing two or more forms configured for receiving data objects for an ad campaign, wherein the two or more forms sufficiently compartmentalize the ad campaign in order to facilitate entry of the data objects, providing a navigation interface configured for facilitating navigation among the two or more forms, receiving the data objects into the two or more forms, and receiving at least one request into the navigation interface.

In still another embodiment, a computer readable medium carrying one or more instructions for building data objects for online display advertising is provided. The one or more instructions, when executed by one or more processors, cause the one or more processors to perform the steps of providing two or more forms configured for receiving data objects for an ad campaign, wherein the two or more forms sufficiently compartmentalize the ad campaign in order to facilitate entry of the data objects, providing a navigation interface configured for facilitating navigation among the two or more forms, receiving the data objects into the two or more forms, and receiving at least one request into the navigation interface.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 shows exemplary exchange entities of an ad exchange, in accordance with an embodiment of the present invention; and

FIG. 2A is a block diagram of a system for building data objects for online display ads, in accordance with an embodiment of the present invention;

FIG. 2B is a more detailed block diagram of the system of FIG. 2A with an exemplary placement of the forms wizard in an ad exchange system, in accordance with an embodiment of the present invention;

FIG. 3 is a schematic diagram of the ad exchange system of FIG. 2B, in accordance with an embodiment of the present invention;

FIG. 4 is a flowchart for a method for building data objects for online display advertising, in accordance with an embodiment of the present invention;

FIG. 5 is an example of a compartmentalized form, in accordance with an embodiment of the present invention;

FIG. 6 is an example of a navigation system within the forms wizard, in accordance with an embodiment of the present invention;

FIG. 7 is an example of a form for a new ad with collapsible modules, in accordance with an embodiment of the present invention;

FIG. 8 is an example of radio buttons and drop-down menus of a form, in accordance with an embodiment of the present invention;

FIG. 9 is an example of tabs of a form, in accordance with an embodiment of the present invention; and

FIG. 10 is an example of an “Edit” button, in accordance with an embodiment of the present invention.

### DETAILED DESCRIPTION OF THE INVENTION

An invention for a method and system for building data objects for online display advertising is disclosed. Numerous specific details are set forth in order to provide a thorough understanding of the present invention. It will be understood, however, to one skilled in the art, that the present invention may be practiced with other specific details.

### Overview of Exchange Entities of an Ad Exchange

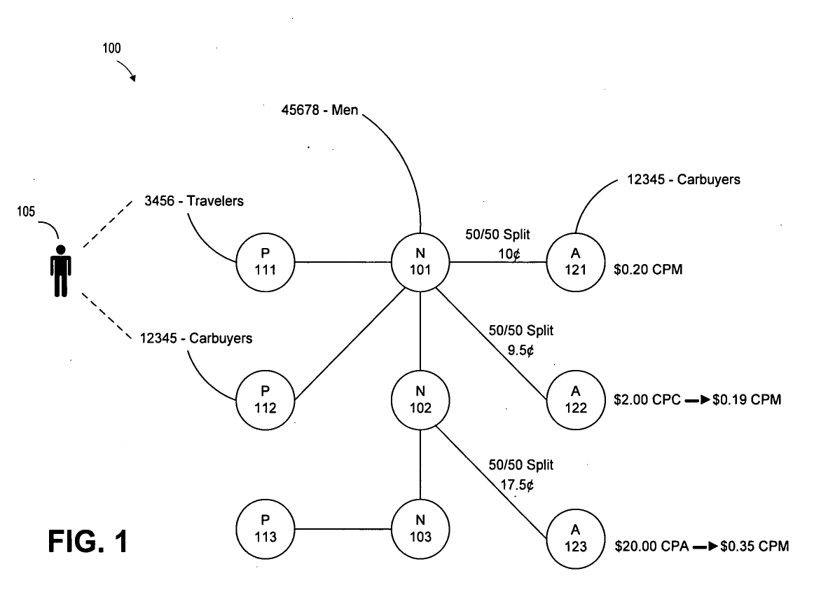

FIG. 1 shows exemplary exchange entities 100 of an ad exchange, in accordance with an embodiment of the present invention. The exchange entities 100 include ad networks 101, 102, 103, publishers 111, 112, 113, and advertisers 121, 122, 123. Examples of an ad network include Yahoo!® Ad Network and MediaNews Group®. One of ordinary skill recognizes that the foregoing entities are exemplary and that the exchange entities 100 may contain other ad networks, publishers, advertisers, and/or other entities.

The publishers 111, 112, 113 preferably have content that is of interest to consumers 105 of such content. For instance, the publisher 112 may have a web page such as Edmunds.com that is directed to car buyers. Users of the Internet may visit the web page to obtain the content provided. Some embodiments log the visits and/or activities of the users on the web page, and further generate segments of users who interact with the content. As shown in the figure, the publisher 111 may have content for travelers, while the publisher 112 has content for car buyers. Each segment preferably has a unique identifier that is unique to the segment, and is also unique to the entity. In this example, the segment “Car Buyers” for the publisher 112 is assigned the identifier “12345,” the segment “Travelers” for the publisher 111 is assigned the identifier “3456,” and the segment “Men” is assigned the identifier “45678” for the ad network 101.

As users and/or segments of users interact with the content provided by the publishers 111, 112, 113, “ad calls” are generated for the publishers' advertising inventory. Generally, in non-guaranteed delivery, the advertisers 121, 122, 123, bid to supply advertising to the available inventory. In this example, the advertiser 121 bids $0.20 CPM, the advertiser 122 bids $2.00 CPC, and the advertiser 123 bids $20.00 CPA. Some systems normalize the bids and/or costs to CPM. Hence, the $2.00 CPC may be normalized to $0.19 CPM, and the $20.00 CPA to $0.35 CPM. Further, the advertisers 121, 122, 123 may have split fee arrangements with the ad networks 101, 102, 103. FIG. 1 illustrates 50/50 split fee arrangements between each advertiser 121, 122, 123, and each ad network 101, 102, 103. More specifically, for the $0.20 CPM the advertiser 121 pays for presentation of its advertising to users/consumers 105, the advertiser pays $0.10 CPM to the ad network 101. Other fee arrangements, however, are recognized by one of ordinary skill.

The advertisers 121, 122, 123 typically have advertising campaigns that include one or more ad creatives that promote a particular brand or product. The advertisers 121, 122, 123 may wish to specify certain criteria for each campaign such as, for example, maximum spend per day on the delivery of advertising, and/or criteria for targeted advertising. Examples of “hard targeting” include directing an advertisement to a particular gender and/or during a particular time of day. The advertisers 121, 122, 123 may further target particular users and/or segments of users. Particular transactions and/or data have additional value for the exchange entities 100. For instance, one or more ads and/or campaigns for the advertiser 121 may have particular relevance to the Car buyers 12345.

In one implementation, an ad manager server maintains a history of attributes for several advertisements, and predicts the value per advertisement in relation to each publisher. The ad server may perform the foregoing alternatively, or in conjunction with, behavioral type targeting based on user data. In some of these embodiments, each user has a cookie space that is used by various entities to store information. For instance, one or more entities of the exchange entities 100 advantageously write into a user's cookie space an integer identifier that corresponds to a particular user segment.

### Overview of Architecture

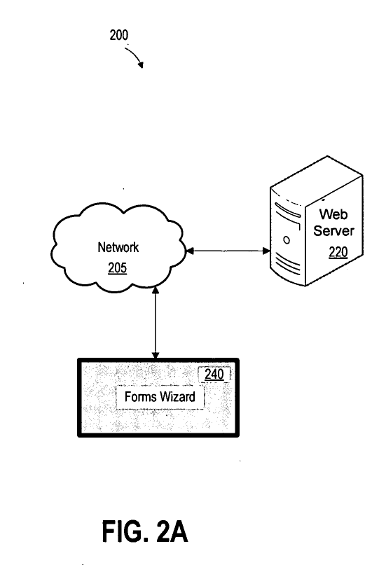

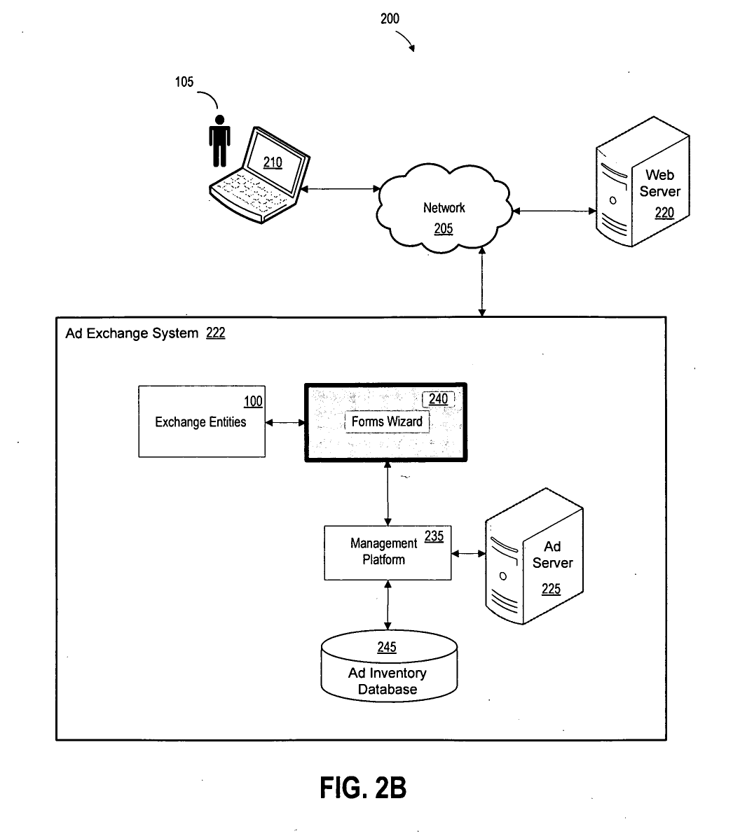

FIG. 2A is a block diagram of a system 200 for building data objects for online display ads, in accordance with an embodiment of the present invention. A device of the present invention is hardware, software or a combination thereof. A device may sometimes be referred to as an apparatus. Each device is configured to carry out one or more steps of the method of building data objects for online display advertising. The network 205 couples together a forms wizard 240 and a web server 220. The network 205 may be any combination of networks, including without limitation the Internet, a local area network, a wide area network, a wireless network and a cellular network. The forms wizard 240 carries out the more important operations of the system 200.

The forms wizard 240 may be located on an application server (not shown) that is coupled to the network 205. A client computer may access the forms wizard 240 via a client computer (not shown) that is coupled to the network 205. The client computer may be, for example, a desktop computer, a laptop computer, a workstation, a smart phone, a cell phone, or a mobile computing device, among other things.

In another embodiment, the forms wizard 240 may operate offline locally at the client computer. Accordingly, the forms wizard 240 may be located entirely on the client computer that is coupled to the network 205. For example, the client computer may locally run the forms wizard 240 after downloading the program from the web server 220. Once the client computer is online again, the forms wizard 240 may carry out appropriate syncing operations. In yet another embodiment, different parts of the forms wizard 240 may reside simultaneously across a combination of different platforms, including without limitation a client computer, an application server, a web server or any other appropriate computing apparatus.

FIG. 2B is a more detailed block diagram of the system 200 of FIG. 2A with an exemplary placement of the forms wizard 240 in an ad exchange system 222, in accordance with an embodiment of the present invention. For explanatory purposes, the forms wizard 240 is located in the ad exchange system 222. However, as discussed above with reference to FIG. 2A, the forms wizard 240 may be loaded on any combination of different computing apparatuses.

The network 205 couples together a consumer computer 210, a web server 220 and an ad exchange system 222. The network 205 may be any combination of networks, including without limitation the Internet, a local area network, a wide area network, a wireless network and a cellular network. The ad exchange system 222 includes without limitation the forms wizard 240, exchange entities 100 of FIG. 1, a management platform 235, an ad server 225 (or ad server system) and an ad inventory database 245. The forms wizard 240 may be accessed via a user interface (not shown). The ad server 225 is coupled to the management platform 235. The management platform is coupled to the forms wizard 240 and the ad inventory database 245. The forms wizard 240 is coupled to the exchange entities 100.

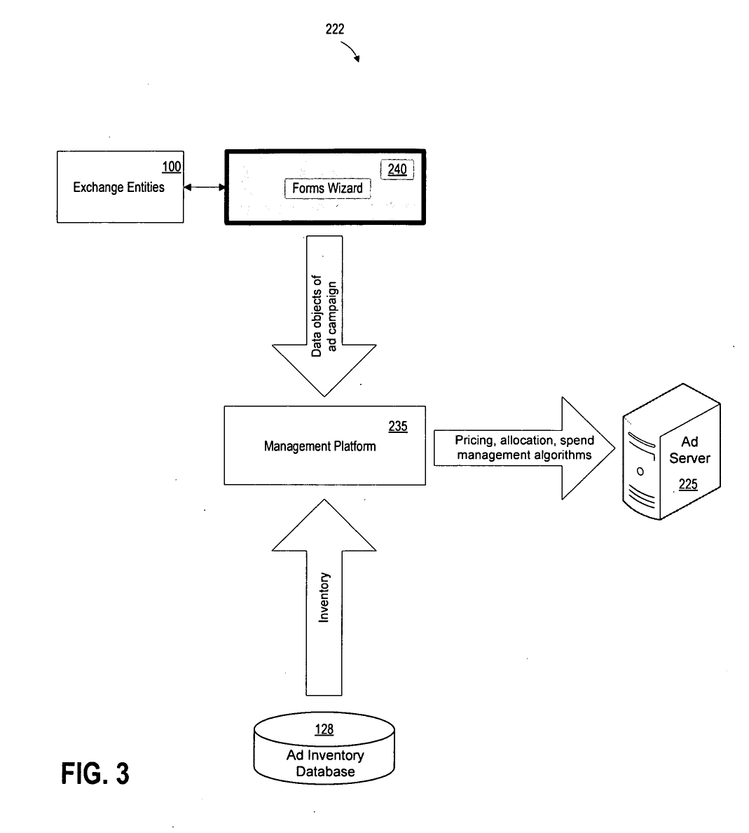

FIG. 3 is a schematic diagram of the ad exchange system 222 of FIG. 2B, in accordance with an embodiment of the present invention. For explanatory purposes, the forms wizard 240 is located in the ad exchange system 222. However, as discussed above with reference to FIG. 2A, the forms wizard 240 may be located simultaneously on a combination of different computing apparatuses. The exchange entities 100 include advertisers that want to advertise with a publisher. The exchange entities 100 include advertisers that want to advertise with the publishers. An ad network (e.g., Yahoo!® Ad Network) in the exchange entities 100 is authorized to deal and establish contracts on behalf of the advertiser. Another ad network (e.g., MediaNews Group®) is authorized to deal and establish contracts on behalf of the publisher. As discussed above with reference to FIG. 1, there may be any number of entities between the outer entities, the advertiser 121 and the publisher 113.

The forms wizard 240 receives data input about an ad campaign from one of the exchange entities 100, in other words, the user. The forms wizard 240 formulates the data input as data objects and sends the data objects to the management platform 235. The management platform 235 consumes the ad campaign (e.g., for sponsored search, contextual advertising, display advertising), which is a conglomeration of data objects from the forms wizard 240.

The forms wizard 240 provides a modular architecture that allows an advertiser to modify a campaign and see its instant effect on ad pricing and ad allocation. The modular architecture also allows an advertiser to plug and play with different ad pricing, ad allocation strategies and various ad inventories. The advertiser may effectively write an ad campaign into a contract using forms of the forms wizard 240.

After the management platform 235 receives the data objects of the ad campaign, the management platform 235 translates (i.e., compiles) the data objects into scripts (i.e., common data structures). The management platform 235 uses the scripts to access the inventory from the ad inventory database 245, to update budgets and to update statistics of impressions (i.e., views of an advertisement), among other things.

### Forms Wizard Functionality

The forms wizard 240 breaks up data input of an ad campaign, which can be rather large, into logical groupings. These logical groupings are forms. Each form is a container for data input. The forms wizard allows a user (e.g., advertiser) to specify various kinds of different data objects for an ad campaign. The data objects may include without limitation data input for auctioning services, data input for the look and feel of specific ads, data input for consumer demographics and data input for websites that the user wishes to target within an ad network, among other things. Auctioning services may include without limitation setting pricing mechanisms, defining terms and conditions of an ad campaign, receiving address and contact information of a user inputting the information, receiving bids for various kinds of impressions (i.e., spaces on consumer webpages), and specifying volume constraints to control exposure of ads on consumer computers, among other things. The forms wizard 240 allows the user to specify succinctly their values and their exposure for a wide variety of different segments for the purpose of matching and clearing ads within the system.

Advertising networks such as those run by Yahoo!®, Ad.com, and Google® provide matching functions that display banners throughout websites in a network of affiliates. The matching is based on the nature of the advertisement, and a bid provided by the advertiser. The trend in display advertising is to allow an advertiser to specify what kinds of consumers the advertiser is targeting. For example, the advertiser may specify users by geographic location, interests, and even online behavior. The forms wizard 240 provides forms to allow the advertiser to specify such information.

The forms wizard 240 has omni-directional data receiving capabilities. In other words, the forms wizard 240 does not have to step a user through the forms in a sequential manner. For example, the forms wizard may start one particular user at the beginning, while starting another particular in a middle form or in the last form. The forms wizard 240 also gives the user the option of deciding where to start or proceed within the sequence of forms. The navigation system of the forms wizard 240 facilitates this omni-directional data entry capability.

The forms wizard 240 facilities data entry of multiple different users who may have various different access privileges. The different users may input data objects at substantially the same time or at different times. Using the omni-directional capabilities, the various users may come into the appropriate form at the desired location. The forms wizard 240 administers the various levels of access privileges, each level having a defined degree of access to appropriate forms. The access privileges may be set by an administrator of the particular ad campaign.

An important purpose of the forms wizard 240 is to encourage the user to input as many data objects as possible. The modular nature of the forms wizard 240 allows a user to complete an ad campaign in digestible chunks. The user may complete a section of information, save that section of information, leave and then come back later to complete other forms. The data input process is less tedious. Accordingly, the forms wizard 240 receives more data objects from the user. The system may then monetize an ad campaign to a substantially high degree of accuracy.

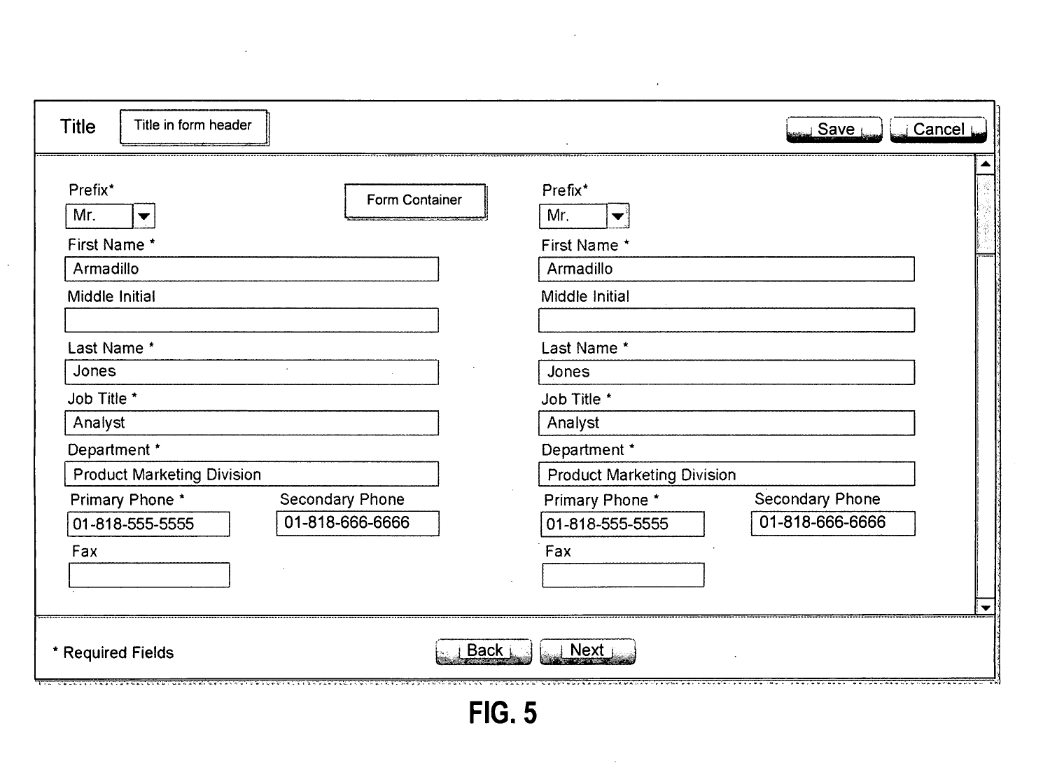

FIGS. 5-9 below illustrate exemplary features of the forms wizard 240. Related features that are not explicitly mentioned here are still within the scope of the forms wizard 240.

FIG. 5 is an example of a compartmentalized form, in accordance with an embodiment of the present invention. The forms wizard 240 provides comprehensive granular data collection by providing compartmentalized forms, like the form shown in FIG. 5. The forms wizard 240 parses a long complex form into sections that are not always required to be completed. The parsing makes the forms completion process substantially less tedious on the user. Form input may include without limitation creating new objects, editing objects, and appending or adding attributes (or other objects) to an existing object. A compartmentalized form collects data objects from the user. This particular form in FIG. 5 collects various identification information and contact information from the user. This form has options to save and to go to the next form. This form is considered compartmentalized because this form embodies just one compartment of the entire ad campaign. The user may save and go to the next form, or the user may save, leave and come back later. The size of a form may be formatted to a size that the user desires.

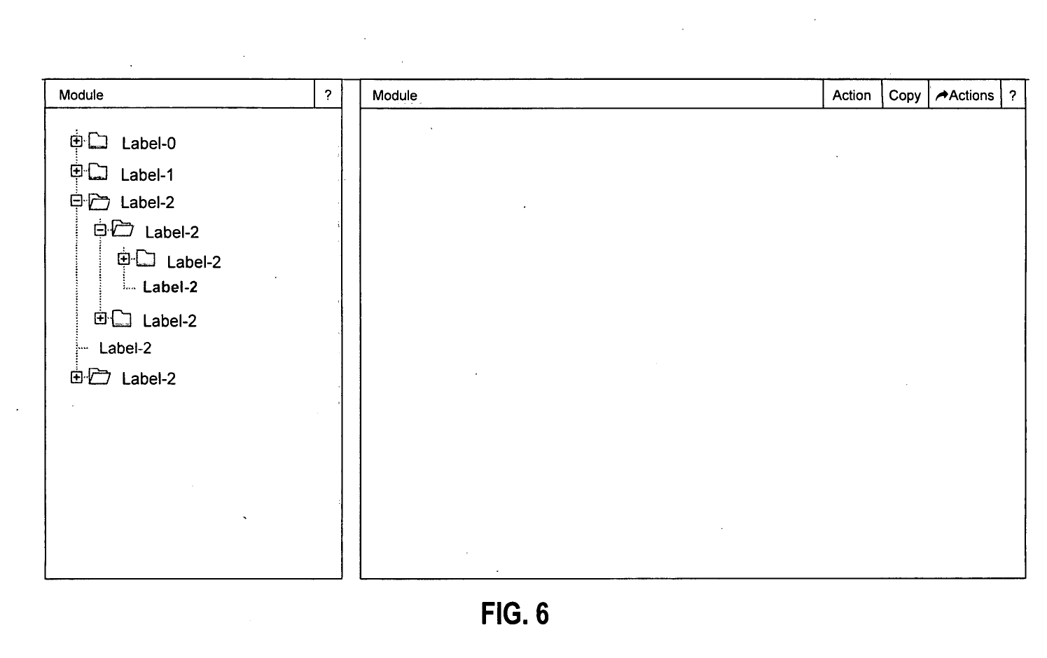

FIG. 6 is an example of a navigation system within the forms wizard, in accordance with an embodiment of the present invention. An important purpose of the forms wizard 240 is to enable access to global navigation, as well as to non-sequential workflows, of an ad campaign. As shown on the left-hand side of FIG. 6, the navigation system is provided in a clickable tree menu format, including labels that correspond to sections of the ad campaign. The labels are organized in a suitable hierarchical manner and may be selected, expanded or collapsed as the user desires.

In some embodiments, user input will persist in the session while stepping through objects in the tree control. If the user attempts to step off the page without explicitly saving or submitting information, then a warning message is triggered in an overlay. The user is allowed to save from the form overlay or make more changes. If the user chooses to cancel from the forms overlay, then no data is committed and the user is allowed to jump to the last clicked page from the stored click path of previously saved forms. If the user chooses to make more changes from the forms overlay, then the user will be returned to the previous screen.

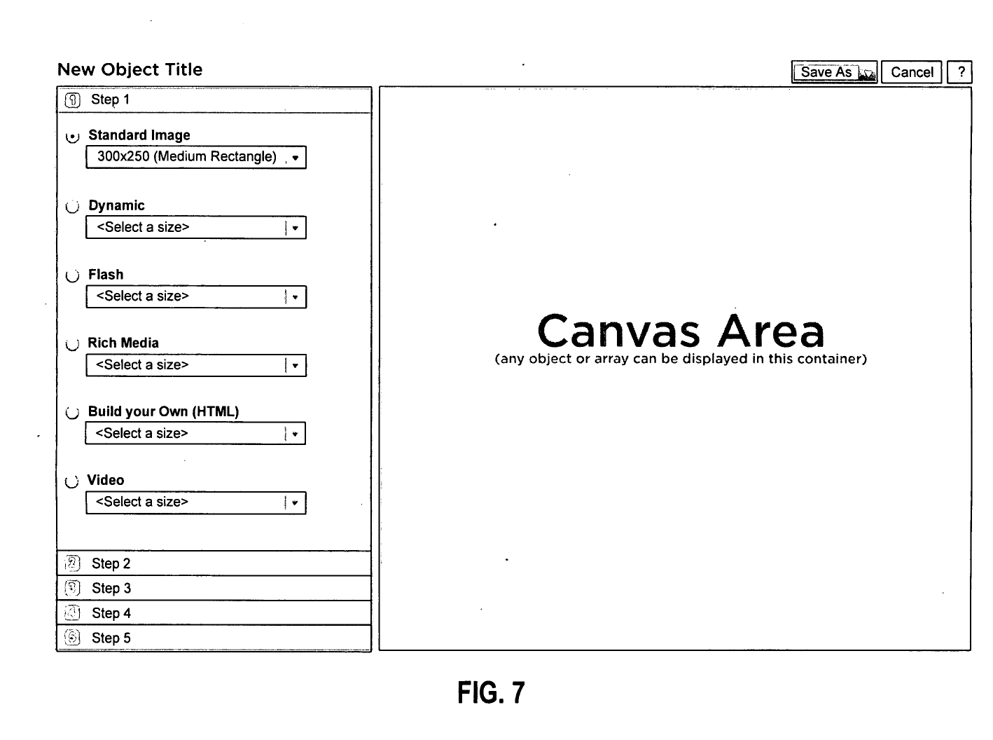

FIG. 7 is an example of a form for a new ad with collapsible modules, in accordance with an embodiment of the present invention. Each collapsible module may collect data objects from the user. The collapsible module may be expanded, edited and then collapsed as desired. Form fields with each module are unlimited, but will require scrolling if the modules are fixed. Modules are conditional in height which is determined by core application requirements. In this particular example, in the left frame, a standard image is selected in the first module (i.e., Step 1), and there are other modules (i.e., Step 2, etc.) that are currently collapsed; in the right frame is a blank canvas where various templates that correspond to the current module in the left frame may be provided for selection.

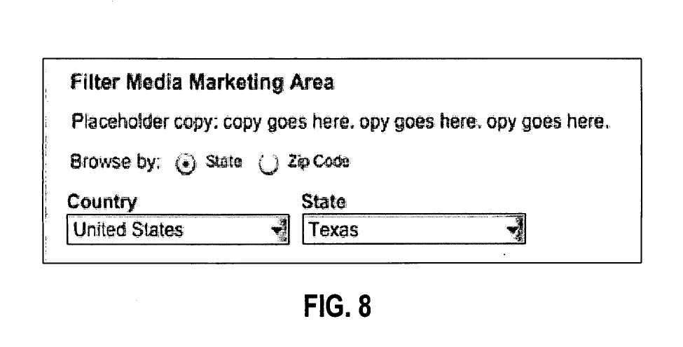

FIG. 8 is an example of radio buttons and drop-down menus of a form, in accordance with an embodiment of the present invention. Radio buttons may be used to show or hide objects. Radio buttons are generally used when a user may select one object out of a set. Radio buttons are generally found in sets. However, if there are more than three options, then it may be more desirable to have a drop-down menu in the form. The radio buttons here allow the user to select a marketing area by state or by zip code. The drop-down menus here allow the user to select the marketing country and state.

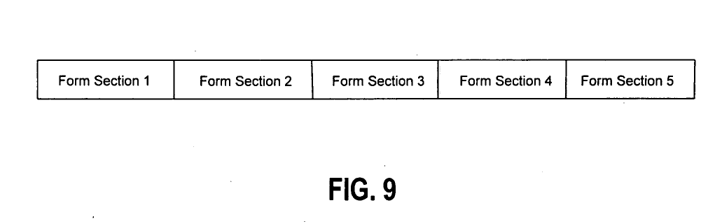

FIG. 9 is an example of tabs of a form, in accordance with an embodiment of the present invention. Tabs provide pagination functionality and are preferably configured in conjunction with a tree menu to optimize depth management interaction. If this tabs feature is configured on a form independent of the tree menu, then the steps shown preferably will need to contain the higher level categories and sub-categories. The example here shows 5 tabs across. A user may click one of the tabs to populate the form container with its respective contents in a frame below the tabs.

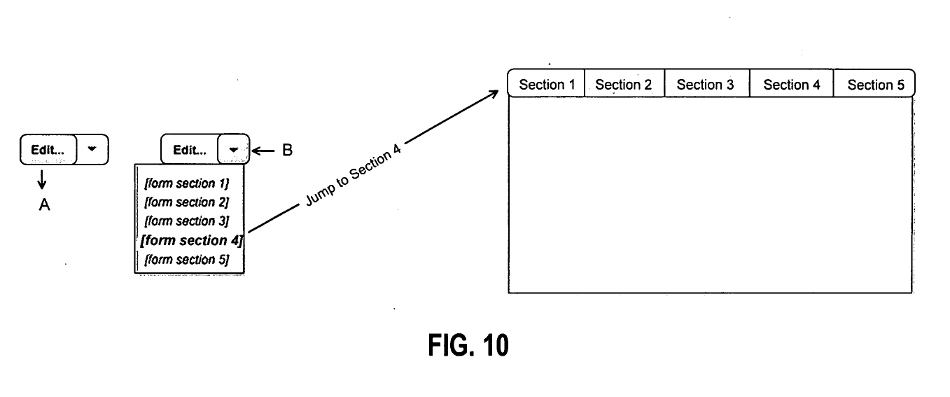

FIG. 10 is an example of an “Edit” button, in accordance with an embodiment of the present invention. Referring to “A”, clicking on the Edit button will take a user to the first section of the forms wizard and assumes the user wants to edit all aspects of an object. Referring to “B”, clicking on the arrow next to the Edit button drops down a selection of forms wizard sections to which the user can jump directly.

Generally, the forms wizard 240 breaks complex data object creation into sub-components with an object builder interface. The object builder interface allows a user to assess quickly the progress of the creation of the object. The object builder interface also facilitates editing of the objects in a non-linear (i.e., omni-directional) way during the object creation process. The forms wizard 240 provides constant feedback and allows nonlinear save. The save functionality allows a user to leave and then return later to complete the creation of the saved data object.

### Method Outline

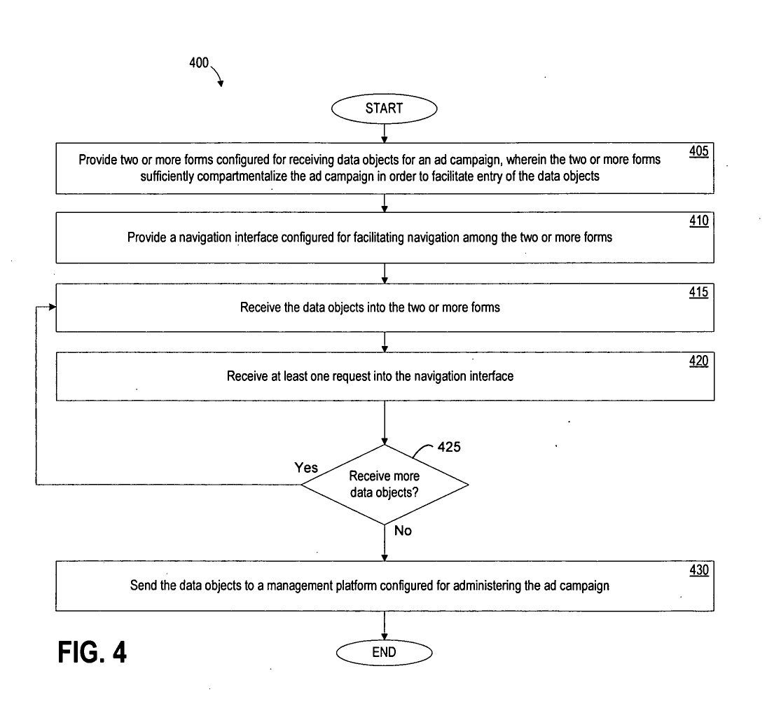

FIG. 4 is a flowchart for a method 400 for building data objects for online display advertising, in accordance with an embodiment of the present invention. The steps of the method 400 may be carried out by the forms wizard or by any combination of devices of the system. The method starts in step 405 where the system provides two or more forms configured for receiving data objects for an ad campaign. The two or more forms sufficiently compartmentalize the ad campaign in order to facilitate entry of the data objects. The method 400 then moves to step 410 where the system provides a navigation interface configured for facilitating navigation among the two ore more forms. Next, in step 415, the system receives the data objects into the two or more forms. The method 400 proceeds to step 420 where the system receives at least one request into the navigation interface.

In decision operation 425, the method 400 then determines if there are more data object to be received. On one hand, if there are more data objects to be received, the system returns to step 415 and continues receiving the data objects. On the other hand, if there are no more data objects to be received, the method 400 moves to step 430 where the system sends the data objects to a management platform configured for administering the ad campaign. The method 400 is then at an end.

### Computer Readable Medium Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application-specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include without limitation any type of disk including floppy disks, mini disks (MD's), optical disks, DVDs, CD-ROMs, micro-drives, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include without limitation device drivers, operating systems, and user applications. Ultimately, such computer readable media further includes software for performing the present invention, as described above.

Included in the programming (software) of the general/specialized computer or microprocessor are software modules for implementing the teachings of the present invention, including without limitation providing two or more forms configured for receiving data objects for an ad campaign, wherein the two or more forms sufficiently compartmentalize the ad campaign in order to facilitate entry of the data objects, providing a navigation interface configured for facilitating navigation among the two or more forms, receiving the data objects into the two or more forms, and receiving at least one request into the navigation interface, according to processes of the present invention.

### Advantages

The system of the present invention facilitates increased data object creation and collection. In an ad exchange system, increased object creation means more ad sales orders and more inventory configuration. The forms wizard provides a better user experience because the form completion process is broken into sections and is not so tedious. The forms wizard provides more effective and efficient data collection preferably using a web browser-based interface.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for building data objects for online display advertising, the method comprising:
providing two or more forms configured for receiving data objects for an ad campaign, wherein the two or more forms sufficiently compartmentalize the ad campaign in order to facilitate entry of the data objects;
providing a navigation interface configured for facilitating navigation among the two or more forms;
receiving the data objects into the two or more forms; and
receiving at least one request into the navigation interface.

2. The method of claim 1, further comprising sending the data objects to a management platform configured for administering the ad campaign.

3. The method of claim 1, wherein the at least one request initiates at least one of:
saving a form;
updating a form;
leaving a form; and
returning to a form.

4. The method of claim 1, wherein the navigation interface is further configured for navigation among the two or more forms in an omni-directional manner.

5. The method of claim 1, wherein the two or more forms are configured for receiving data input for at least one of:
auctioning services;
a look and feel of an ad;
demographics of consumers; and
websites that a user wishes to target within an ad network.

6. The method of claim 5, wherein the auctioning services include at least one of:
setting pricing mechanisms;
defining a term of an ad campaign;
defining a condition of an ad campaign;
defining inventory on a publisher site;
receiving address information of at least one of a user, a company, and managed entity;
receiving contact information of at least one of a user, a company, and managed entity;
defining parameters for an ad creative;
receiving a bid for an impression; and
specifying a volume constraint to control exposure of an ad.

7. The method of claim 1, further comprising:
setting two or more access privilege levels for two or more users; and
receiving input into the two or more forms from the two or more users at substantially a same time.

8. The method of claim 1, further comprising:
setting two or more access privilege levels for two or more users; and
receiving input into the two or more forms from the two or more users at a different time.

9. The method of claim 1, further comprising receiving at least one of:
a request to create a new data object;
a request to edit a data object; and
a request to add an attribute to an existing data object.

10. The method of claim 1, wherein the navigation interface includes a clickable tree menu with labels corresponding to sections of the ad campaign, wherein the labels are organized in a suitable hierarchical manner.

11. A system for building data objects for online display advertising, wherein the system is configured for:
providing two or more forms configured for receiving data objects for an ad campaign, wherein the two or more forms sufficiently compartmentalize the ad campaign in order to facilitate entry of the data objects;
providing a navigation interface configured for facilitating navigation among the two or more forms;
receiving the data objects into the two or more forms; and
receiving at least one request into the navigation interface.

12. The system of claim 11, wherein the system is further configured for sending the data objects to a management platform configured for administering the ad campaign.

13. The system of claim 11, wherein the at least one request initiates at least one of:
saving a form;
updating a form;
leaving a form; and
returning to a form.

14. The system of claim 11, wherein the navigation interface is further configured for navigation among the two or more forms in an omni-directional manner.

15. The system of claim 11, wherein the two or more forms are configured for receiving data input for at least one of:
auctioning services;
a look and feel of an ad;
demographics of consumers; and
websites that a user wishes to target within an ad network.

16. The system of claim 15, wherein the auctioning services include at least one of:
defining a term of an ad campaign;
defining a condition of an ad campaign;
defining inventory on a publisher site;
receiving address information of at least one of a user, a company, and managed entity;
receiving contact information of at least one of a user, a company, and managed entity;
defining parameters for an ad creative;
receiving a bid for an impression; and
specifying a volume constraint to control exposure of an ad.

17. The system of claim 11, wherein the system is further configured for:
setting two or more access privilege levels for two or more users; and
receiving input into the two or more forms from the two or more users at substantially a same time.

18. The system of claim 11, wherein the system is further configured for:
setting two or more access privilege levels for two or more users; and
receiving input into the two or more forms from the two or more users at a different time.

19. The system of claim 11, wherein the system is further configured for: receiving at least one of:
a request to create a new data object;
a request to edit a data object; and
a request to add an attribute to an existing data object.

20. The system of claim 11, wherein the navigation interface includes a clickable tree menu with labels corresponding to sections of the ad campaign, wherein the labels are organized in a suitable hierarchical manner.

21. A computer readable medium carrying one or more instructions for building data objects for online display advertising, wherein the one or more instructions, when executed by one or more processors, cause the one or more processors to perform the steps of:
providing two or more forms configured for receiving data objects for an ad campaign, wherein the two or more forms sufficiently compartmentalize the ad campaign in order to facilitate entry of the data objects;
providing a navigation interface configured for facilitating navigation among the two or more forms;
receiving the data objects into the two or more forms; and
receiving at least one request into the navigation interface.
